(19) United States
(12) Patent Application Publication
(10) Pub. No.: US 2022/0097627 A1
(43) Pub. Date: Mar. 31, 2022

(54) AUTOMOTIVE ORNAMENT AND MANUFACTURING METHOD THEREOF

(71) Applicant: Hiroca Automotive Trim Corporation, Taoyuan City (TW)

(72) Inventors: Wu Chuan Chuang, Hsinchu City (TW); Shuming Lee, Hsinchu County (TW)

(73) Assignee: Hiroca Automotive Trim Corporation, Taoyuan City (TW)

(21) Appl. No.: 17/117,117

(22) Filed: Dec. 10, 2020

(30) Foreign Application Priority Data
Sep. 30, 2020 (TW) 109134299

(51) Int. Cl. B60R 13/00; F21V 19/00; B60Q 3/30; B60Q 3/80; B32B 21/14; B32B 27/40; B32B 27/36; B32B 21/08

(52) U.S. Cl. CPC B60R 13/00; F21V 19/0015; B60Q 3/30; B60Q 3/80; F21W 2104/00; B32B 27/40; B32B 27/365; B32B 21/08; B32B 21/14

(57) ABSTRACT

An automotive ornament including a substrate, a texture layer and a transparent layer is provided. The substrate has a first surface and a second surface opposite to the first surface. The texture layer is located on the first surface, wherein the texture layer includes a texture pattern. The transparent layer extends from a top surface of the texture layer to cover a sidewall of the texture layer and a sidewall of the substrate. The transparent layer covers the texture pattern, and the texture layer has a degree of stretching less than the transparent layer. A manufacturing method of automotive ornament is also provided.

### CROSS-REFERENCE TO RELATED APPLICATION

This application claims the priority benefit of Taiwan application serial no. 109134299, filed on Sep. 30, 2020. The entirety of the above-mentioned patent application is hereby incorporated by reference herein and made a part of this specification.

### BACKGROUND

### Technical Field

The disclosure relates to an ornament and a manufacturing method thereof, and more particularly to an automotive ornament and a manufacturing method thereof.

### Description of Related Art

Generally, in the production of automotive ornaments, a leather surface has its texture. In addition, a texture layer with a texture pattern is formed on the leather, and then the leather and the texture layer with the texture pattern are combined together. After that, the operations of covering and stretching are carried out altogether. However, due to the difference in the stretchability between the leather and the texture layer, in order to match the stretchability during the covering process, a corresponding stretching force needs to be applied, causing the texture pattern of the texture layer to offset and to be located difficultly. In addition, the texture pattern will also be deformed due to the tensile force. Therefore, how to effectively improve the positioning and deformation of the texture pattern is a big challenge for those skilled in the art.

### SUMMARY

The disclosure provides an automotive ornament and a manufacturing method thereof capable of effectively improving problems such as the positioning and deformation of the texture pattern.

An automotive ornament of the disclosure includes a substrate, a texture layer, and a transparent layer. The substrate has a first surface and a second surface opposite to the first surface. The texture layer is located on the first surface. The texture layer includes a texture pattern. The transparent layer extends from the top surface of the texture layer to cover the sidewall of the texture layer and the sidewall of the substrate. The transparent layer covers the texture pattern, and the texture layer has a degree of stretching less than that of the transparent layer.

In an embodiment of the disclosure, the transparent layer includes a transparent leather, an adhesive film, or wood veneer.

In an embodiment of the disclosure, the texture layer includes ink or black paint.

In an embodiment of the disclosure, the automotive ornament further includes a thickening layer. The thickening layer is located between the substrate and the transparent layer. The thickening layer is composed of a transparent substrate, a leather layer, and a texture layer, and the thickening layer extends from the first surface of the substrate to cover the sidewall of the substrate.

In an embodiment of the disclosure, the automotive ornament further includes a light-emitting element and a circuit board. The light-emitting element and the circuit board are both disposed on the second surface of the substrate, and the light-emitting element and the circuit board are electrically connected.

In an embodiment of the disclosure, the light-emitting element is a micro light-emitting element in the circuit board.

The manufacturing method of an automotive ornament of the disclosure at least includes the following steps. A substrate with a texture layer on the surface is provided. The texture layer includes a texture pattern. The transparent layer is stretched so that the transparent layer extends from the top surface of the texture layer to cover the sidewall of the texture layer and the sidewall of the substrate. The transparent layer covers the texture pattern, and the texture layer has a degree of stretching less than that of the transparent layer.

In an embodiment of the disclosure, the transparent layer includes an adhesive film formed by a three-dimensional overlay method.

In an embodiment of the disclosure, the texture layer is not substantially stretched when the transparent layer is stretched.

Based on the above, the automotive ornament of the disclosure is stretched by the transparent layer to cover the top surface and the sidewall of the texture layer and the sidewall of the substrate, instead of combining the transparent layer and the texture layer and then to be stretched and to cover together. Therefore, the texture pattern in the texture layer is not offset or deformed due to the influence of the stretching force, so that problems such as the positioning and deformation of the texture pattern are effectively improved. Furthermore, the automotive ornament of the disclosure may have advantages such as simplifying the manufacturing process, reducing manufacturing costs, improving manufacturing efficiency, manufacturing yield, processing efficiency, and processing yield. In addition, since the texture pattern is covered by the transparent layer, the product surface have a dark decorative effect when the light source is not yet provided to the automotive ornament. When the light source is provided to the automotive ornament, due to the characteristic of the transparency of the transparent layer, the texture pattern produces a decorative effect, which improves the diversity of the automotive ornament.

In order to make the aforementioned features and advantages of the disclosure comprehensible, embodiments accompanied with drawings are described in detail below.

### BRIEF DESCRIPTION OF THE DRAWINGS

FIG. 1A to FIG. 1C are partial cross-sectional schematic views of part of a manufacturing method of an automotive ornament according to an embodiment of the disclosure.

FIG. 2 to FIG. 9 are partial cross-sectional schematic views of part of a manufacturing method of an automotive ornament according to some embodiments of the disclosure.

FIG. 10A to FIG. 10D are partial cross-sectional schematic views of part of a manufacturing method of an automotive ornament according to still another embodiment of the disclosure.

FIG. 11 to FIG. 12 are partial cross-sectional schematic views of part of a manufacturing method of an automotive ornament according to still other embodiments of the disclosure.

FIG. 13 is a flowchart of steps of a manufacturing method of an automotive ornament according to an embodiment of the disclosure.

### DESCRIPTION OF THE EMBODIMENTS

Directional terminology mentioned in the specification, such as “top”, “bottom”, “front”, “back”, “left”, “right”, etc., is used with reference to the orientation of the drawings being described. Therefore, the used directional terminology is only intended to illustrate, rather than limit, the disclosure.

Unless specifically stated otherwise, any method described in the specification is not intended to be interpreted as requiring its steps to be performed in a specific order.

With reference to the drawings of the embodiments, the disclosure is fully illustrated. However, the disclosure can also be implemented in various different forms and should not be limited to the embodiments described in the specification. For clarity, a relative size, a thickness, and a location of each film layer, region, and/or structure may be enlarged. The same or similar elements will be given the same or similar reference numerals and their description will be omitted.

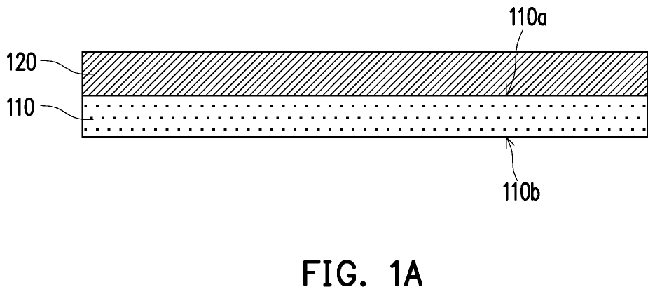

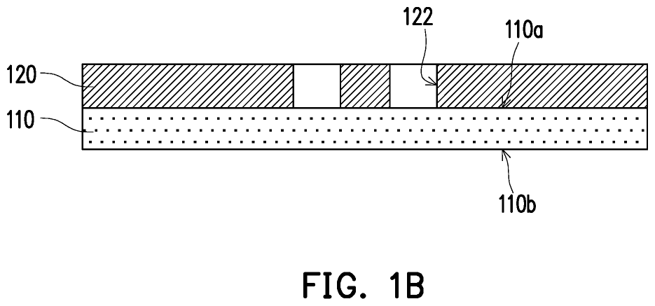

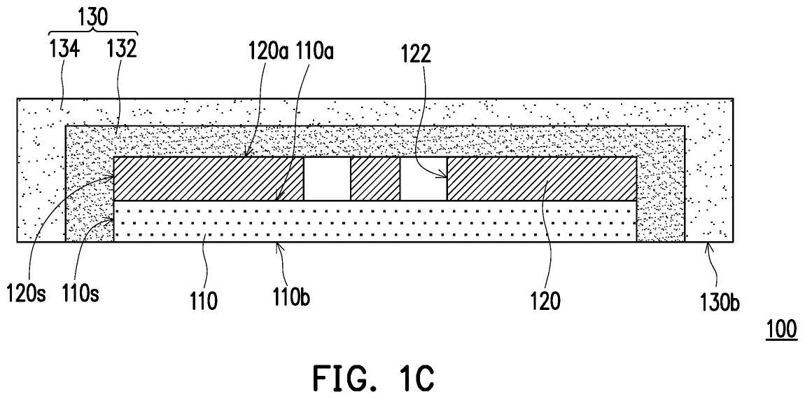

FIG. 1A to FIG. 1C are partial cross-sectional schematic views of part of a manufacturing method of an automotive ornament according to an embodiment of the disclosure.

Refer to FIG. 1A. In the embodiment, the manufacturing process of an automotive ornament 100 includes the following steps. First, a substrate 110 is provided. The substrate 110 has a first surface 110a and a second surface 110b opposite to the first surface 110a.

In some embodiments, the substrate 110 is, for example, polycarbonate (PC). However, the disclosure is not limited thereto. The substrate 110 may be any other suitable material, as long as the substrate 110 can carry the elements or film layers subsequently formed thereon and withstand subsequent manufacturing processes.

Refer to FIG. 1A. A texture layer 120 is formed on the substrate 110. For example, the texture layer 120 may be formed on the first surface 110a of the substrate 110. In the embodiment, the texture layer 120 is, for example, a black paint with a masking function formed by a spraying process, but the disclosure is not limited thereto. In other embodiments, the texture layer 120 may be formed using other materials and processes.

Refer to FIG. 1B. A texture pattern 122 is formed in the texture layer 120. For example, the texture pattern 122 may be formed in the texture layer 120 by laser engraving, but the disclosure is not limited thereto. As long as the texture layer 120 has the texture pattern 122, it falls within the protection scope of the disclosure. The texture pattern 122 is, for example, a plurality of openings on the texture layer 120 exposing the underlying substrate 110, as shown in FIG. 1B. However, the disclosure is not limited thereto, in not shown embodiments, the texture layer has no opening and the texture layer is a patterned texture layer, wherein the patterned texture layer is formed by blister molding or in-Mold Decoration (INS) molding, and the pattern is formed by printing. Moreover, a material of the patterned texture layer has a characteristic of transparency, so that the light can pass through the patterned texture layer even though the patterned texture layer without opening, therefore, the process of forming the opening can be omitted.

Refer to FIG. 1C. A transparent layer 130 is formed on the texture layer 120, wherein the transparent layer 130 has a characteristic of transparency. For example, the light transmittance of the transparent layer 130 is at least greater than 0%, but the disclosure is not limited thereto. The light transmittance may be adjusted according to actual design requirements.

Furthermore, the transparent layer 130 is stretched so that the transparent layer 130 extends from a top surface 120a of the texture layer 120 to cover a sidewall 120s of the texture layer 120 and a sidewall 110s of the substrate 110. The transparent layer 130 covers the texture pattern 122, and the texture layer 120 may have a degree of stretching less than that of the transparent layer 130. After the manufacturing process, the manufacturing of the automotive ornament 100 of the embodiment is substantially completed.

In the embodiment, the automotive ornament 100 is stretched by the transparent layer 130 to cover the top surface 120a and the sidewall 120s of the texture layer 120 and the sidewall 110s of the substrate 110, instead of combining the transparent layer and the texture layer and then to be stretched and to cover together. Therefore, the texture pattern 122 in the texture layer 120 is not offset or deformed due to the influence of the stretching force, so that problems such as the positioning and deformation of the texture pattern 122 are effectively improved.

Furthermore, the automotive ornament 100 may have advantages such as simplifying the manufacturing process, reducing manufacturing costs, improving manufacturing efficiency, manufacturing yield, processing efficiency, and processing yield. In addition, since the texture pattern 122 is covered by the transparent layer 130, the product surface have a dark decorative effect when the light source is not yet provided to the automotive ornament 100. When the light source is provided to the automotive ornament 100, due to the characteristics of the transparency of the transparent layer 130, the texture pattern 122 produces a decorative effect, which improves the diversity of the automotive ornament 100.

In some embodiments, the transparent layer 130 may not substantially stretch the texture layer 120 during the covering process. In other words, the degree of stretching of the texture layer 120 may be close to 0% during the covering process. However, the disclosure is not limited thereto.

Refer to FIG. 1C. In the embodiment, the transparent layer 130 may be a transparent leather composed of a transparent substrate 132 and a leather layer 134. The transparent leather may be at least semi-transparent, but the disclosure is not limited thereto. In some embodiments, the transparent substrate 132 is, for example, polyethylene terephthalate (PET); and the leather layer 134 is, for example, polyurethane (PU) or thermoplastic elastomer (TPE).

In addition, a bottom surface 130b of the transparent layer 130 may be substantially coplanar with the second surface 110b of the substrate 110, but the disclosure is not limited thereto. In other embodiments not illustrated, the transparent layer 130 may further cover the second surface 110b of the substrate 110 to improve the characteristics of covering of the automotive ornament 100.

Note that the following embodiments apply the element reference numerals and part of the content of the foregoing embodiments, the same or similar reference numerals are used to represent the same or similar elements, and the description of the same technical content is omitted. For the description of the omitted parts, refer to the foregoing embodiments, and it is not iterated in the following embodiments.

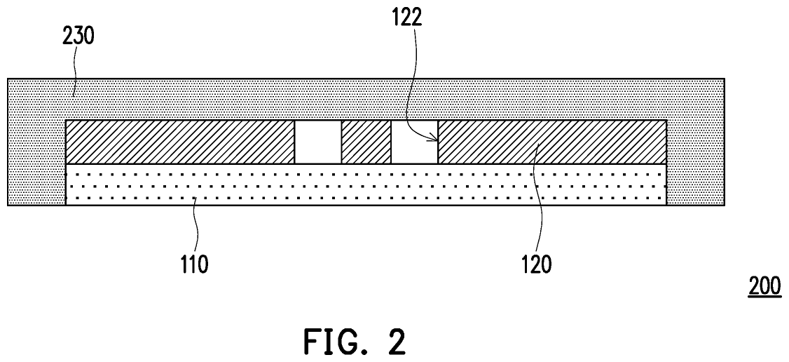

FIG. 2 to FIG. 9 are partial cross-sectional schematic views of part of a manufacturing method of an automotive ornament according to some embodiments of the disclosure.

Refer to FIG. 2. Compared to the automotive ornament 100 of the embodiment in FIG. 1C, a transparent layer 230 of the automotive ornament 200 in the embodiment is an adhesive film. For example, a three-dimensional overlay method (TOM) may be adopted to form the adhesive film (TOM adhesive film), but the disclosure is not limited thereto.

In some embodiments, the adhesive film only needs to have a characteristic of transparency, and the light transmittance of the adhesive film may be adjusted according to actual design requirements.

In some embodiments, the transparent layer 230 may be formed by blister molding, but the disclosure is not limited thereto.

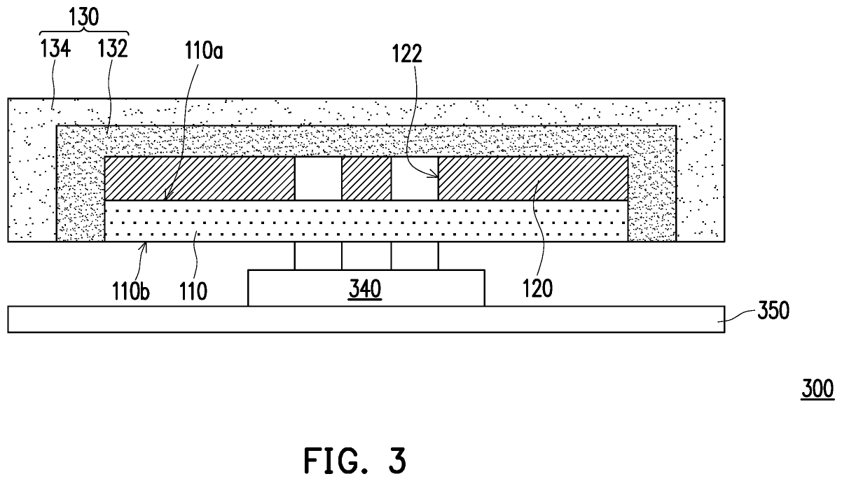

Refer to FIG. 3. Compared to the automotive ornament 100 of the embodiment in FIG. 1C, the automotive ornament 300 in the embodiment further includes a light-emitting element 340 and a circuit board 350. The light-emitting element 340 and the circuit board 350 are both disposed on the second surface 110b of the substrate 110, and the light-emitting element 340 is electrically connected to the circuit board 350, so that the light-emitting element 340 may serve as the light source of the automotive ornament 300. Therefore, the automotive ornament 300 may have the ability to adjust the brightness and light-emitting timing of the light source itself to further enhance the diversity of ornaments, but the disclosure is not limited thereto.

In some embodiments, the light-emitting element 340 is, for example, a light-emitting diode (LED), but the disclosure is not limited thereto.

Note that the configuration and the position of the light-emitting element 340 are not limited in the disclosure. As long as the texture pattern 122 produces a decorative effect with the light emitted by the light-emitting element 340, it falls within the protection scope of the disclosure.

In some embodiments, the light-emitting element 340 may be a micro light-emitting element in the circuit board 350 to improve configuration flexibility, but the disclosure is not limited thereto. The micro light-emitting element is, for example, a micro light-emitting diode.

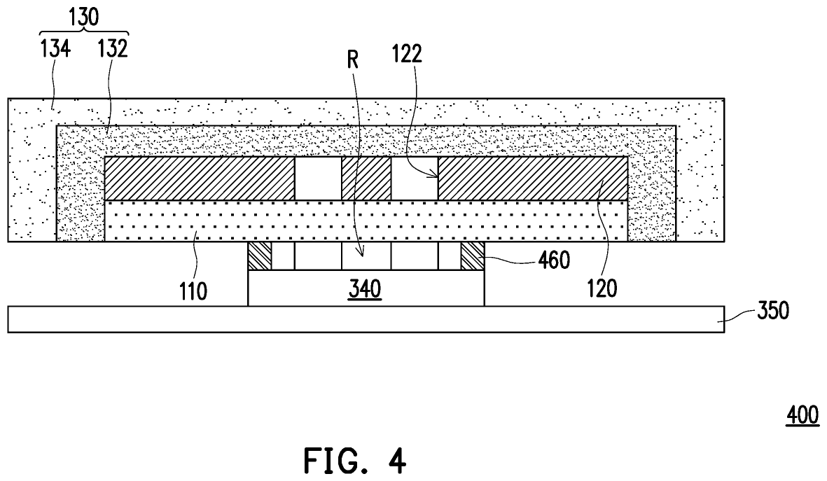

Refer to FIG. 4. Compared to the automotive ornament 300 of the embodiment in FIG. 3, an automotive ornament 400 of the embodiment further includes a light blocking bracket 460 surrounding a light-emitting area R of the light-emitting element 340, so that the light loss of the light-emitting element 340 is reduced, and the light-gathering effect is improved, but the disclosure is not limited thereto.

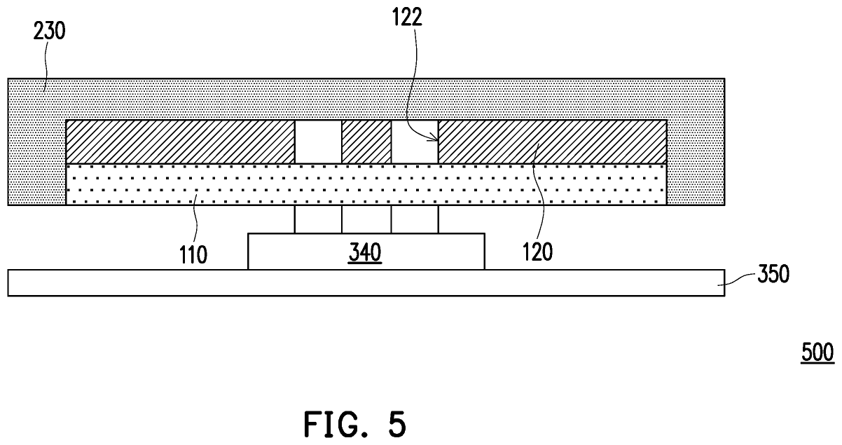

Refer to FIG. 5. Compared to the automotive ornament 200 of the embodiment in FIG. 2, an automotive ornament 500 of the embodiment further includes the light-emitting element 340 and the circuit board 350. The descriptions of the light-emitting element 340 and the circuit board 350 are similar to the technical content in the foregoing embodiment, which is not iterated.

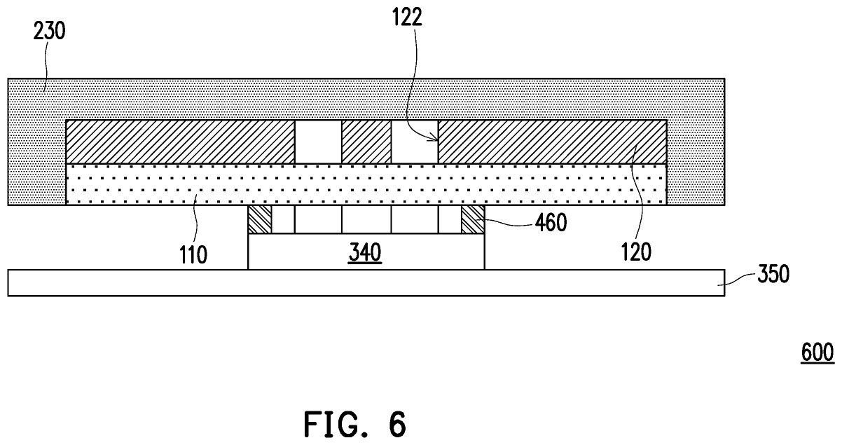

Refer to FIG. 6. Compared to the automotive ornament 500 of the embodiment in FIG. 5, an automotive ornament 600 of the embodiment further includes the light blocking bracket 460. The description of the light blocking bracket 460 is similar to the technical content in the foregoing embodiment, which is not iterated.

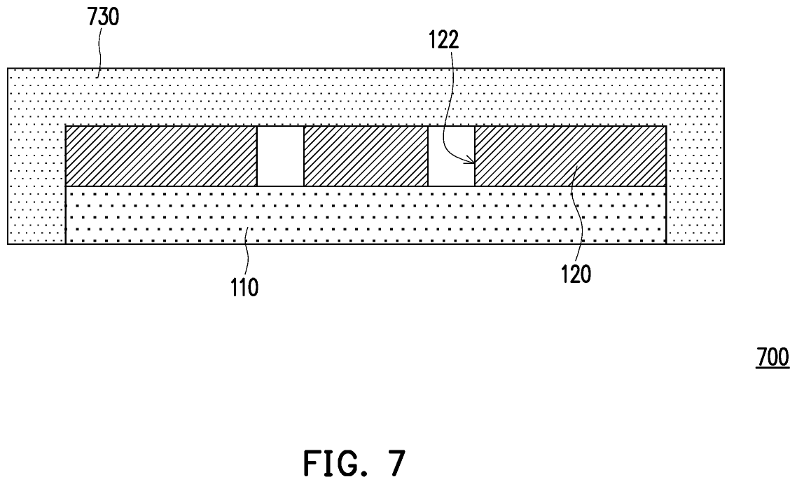

Refer to FIG. 7. Compared to the automotive ornament 100 of the embodiment in

FIG. 1C, a transparent layer 730 of an automotive ornament 700 in the embodiment is wood veneer. The wood veneer may have a characteristic of transparency, and the light transmittance may be determined by the selected wood veneer material. The wood veneer may be any suitable wood decoration material that is known for those skilled in the art.

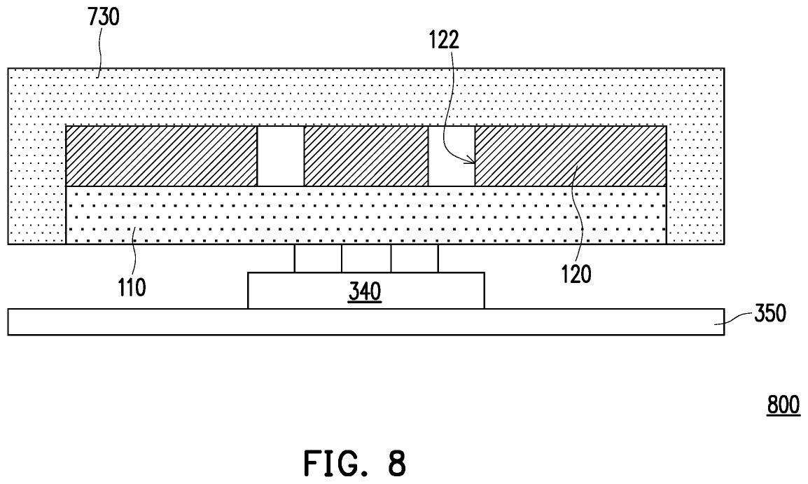

Refer to FIG. 8. Compared to the automotive ornament 700 of the embodiment in FIG. 7, the automotive ornament 800 of the embodiment further includes the light-emitting element 340 and the circuit board 350. The descriptions of the light-emitting element 340 and the circuit board 350 are similar to the technical content in the foregoing embodiment, which is not iterated.

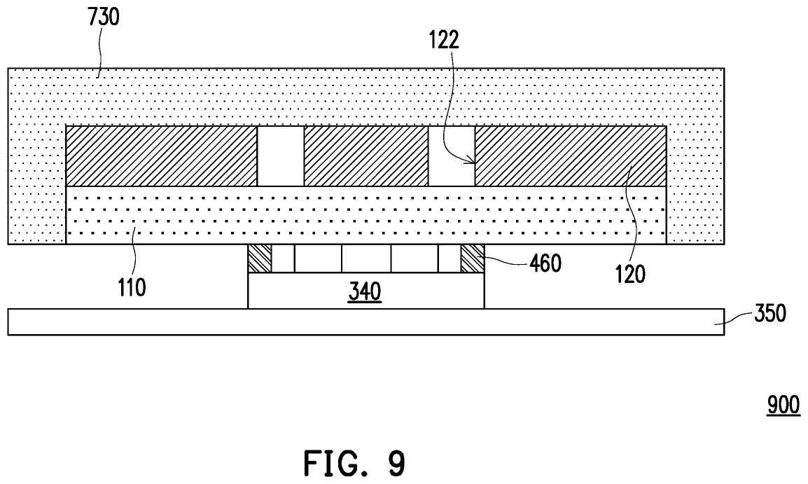

Refer to FIG. 9. Compared to the automotive ornament 800 of the embodiment in FIG. 8, the automotive ornament 900 of the embodiment further includes the light blocking bracket 460. The description of the light blocking bracket 460 is similar to the technical content in the foregoing embodiment, which is not iterated.

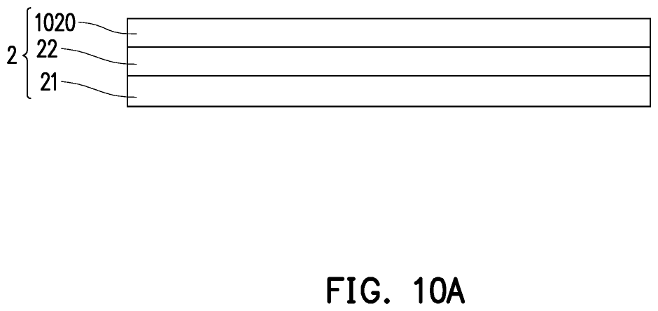

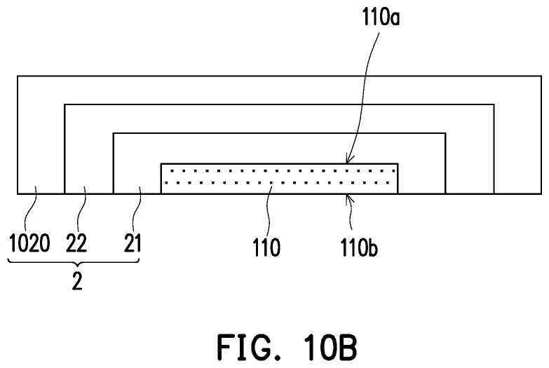

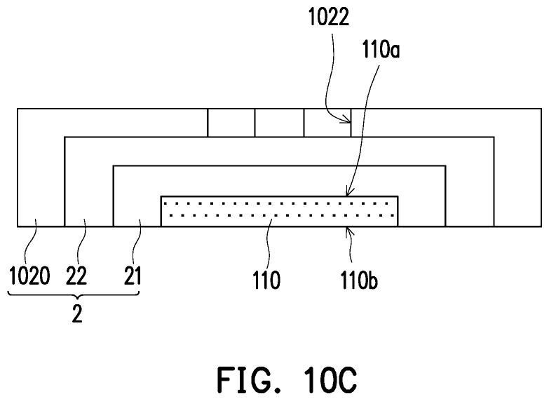

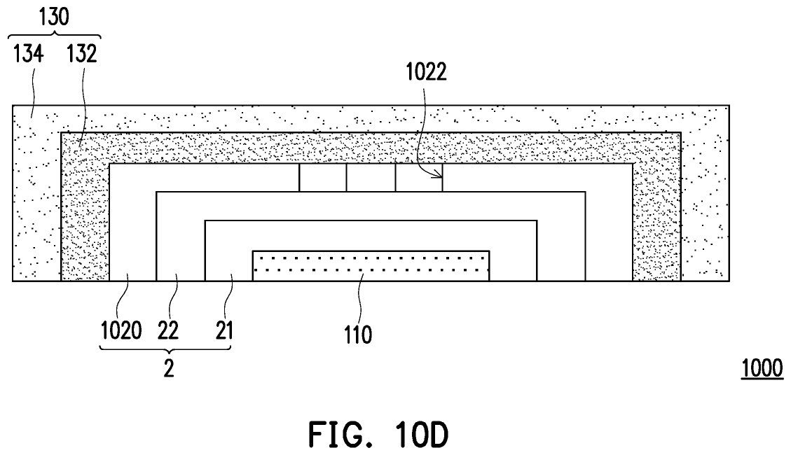

FIG. 10A to FIG. 10D are partial cross-sectional schematic views of part of a manufacturing method of an automotive ornament according to still another embodiment of the disclosure.

In the embodiment, the manufacturing process of the automotive ornament 1000 includes the following steps. Refer to FIG. 10A. First, a thickening layer 2 is provided. The thickening layer 2 may be composed of a transparent substrate 21, a leather layer 22, and a texture layer 1020. In one embodiment, the leather layer 22 and the texture layer 1020 are formed on the transparent substrate 21 by a printing process. In addition, the texture layer 1020 is, for example, ink. The descriptions of the transparent substrate 21 and the leather layer 22 are similar to the technical content of the transparent substrate 132 and the leather layer 134, which is not iterated.

Refer to FIG. 10B. The thickening layer 2 is formed on the substrate 110. For example, the thickening layer 2 is stretched so that the thickening layer 2 extends from the top surface 110a of the substrate 110 to cover the sidewall of the substrate 110, but the disclosure is not limited thereto.

In some embodiments, the thickening layer 2 may further cover the second surface 110b (not shown) of the substrate 110 to improve the characteristic of covering of the product, but the disclosure is not limited thereto.

Refer to FIG. 10C. A texture pattern 1022 is formed in the texture layer 1020. For example, the texture pattern 1022 may be formed in the texture layer 1020 by printing, but the disclosure is not limited thereto. The texture pattern 1022 is, for example, a plurality of openings on the texture layer 1020 exposing the underlying leather layer 22, as shown in FIG. 10C.

Refer to FIG. 10D. A transparent layer 130 is formed on the texture layer 1020. The description of the transparent layer 130 is similar to the technical content in the foregoing embodiment, which is not iterated. After the manufacturing process, the manufacturing of the automotive ornament 1000 of the embodiment is substantially completed.

Since the thickness of the transparent layer 130 is very thin, in the embodiment, with the thickening layer 2, the overall thickness of the automotive ornament 1000 is improved, and thereby achieving a better decorative effect. In addition, since the texture pattern 1022 may produce defects (in a checked shape) in the opening during production, with the transparent substrate 21 in the thickening layer 2, the probability of the appearance of the defects in the opening of the texture pattern 1022 is reduced. However, the disclosure is not limited thereto. In addition, the thickening layer 2 may also have the function of improving the flexibility of the automotive ornament 1000, but the disclosure is not limited thereto.

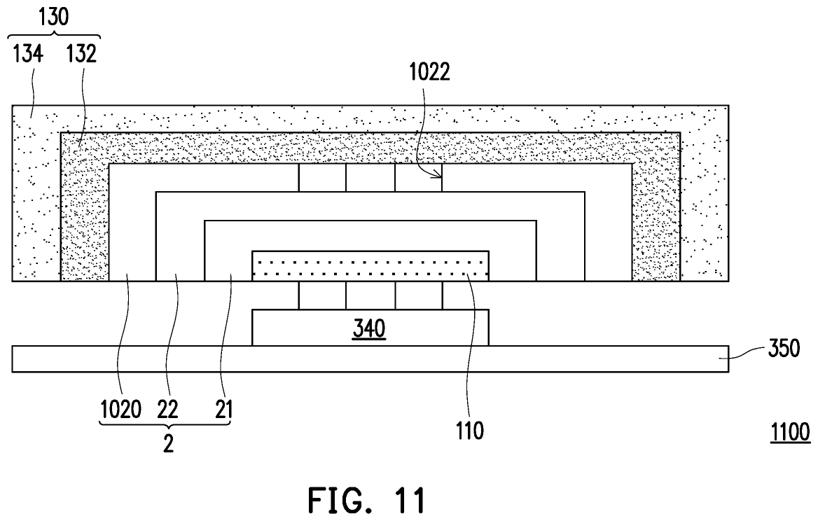

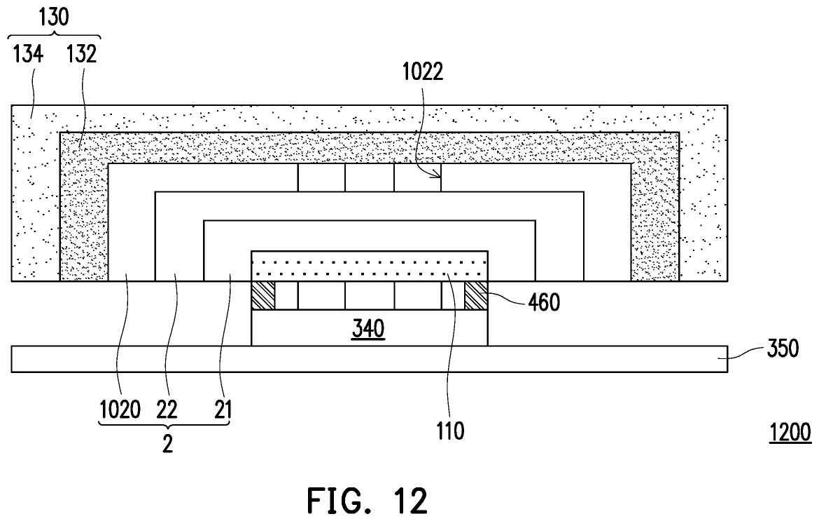

FIG. 11 to FIG. 12 are partial cross-sectional schematic views of part of a manufacturing method of an automotive ornament according to still other embodiments of the disclosure.

Refer to FIG. 11. Compared to the automotive ornament 1000 of the embodiment in FIG. 10D, the automotive ornament 1100 of the embodiment further includes the light-emitting element 340 and the circuit board 350. The descriptions of the light-emitting element 340 and the circuit board 350 are similar to the technical content in the foregoing embodiment, which is not iterated.

Refer to FIG. 12. Compared to the automotive ornament 1100 of the embodiment of FIG. 11, an automotive ornament 1200 of the embodiment further includes the light blocking bracket 460. The description of the light blocking bracket 460 is similar to the technical content in the foregoing embodiment, which is not iterated.

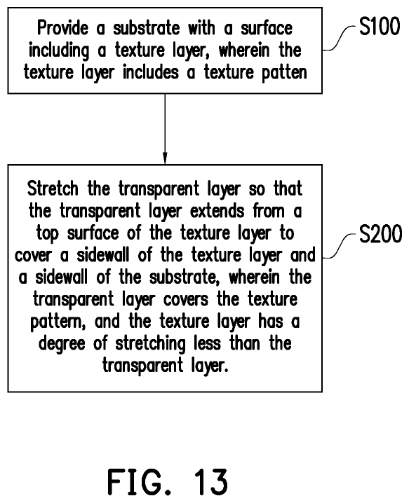

FIG. 13 is a flowchart of steps of a manufacturing method of an automotive ornament according to an embodiment of the disclosure. Referring to FIG. 13, a flowchart of the manufacturing method of the automotive ornament in FIG. 1A to FIG. 1C is provided.

In step S100, a substrate on which has a texture layer on the surface is disposed. The texture layer includes a texture pattern. Refer to, for example, FIG. 1A to FIG. 1B.

In step S200, the transparent layer is stretched so that the transparent layer extends from the top surface of the texture layer to cover the side wall of the texture layer and the side wall of the substrate. The transparent layer covers the texture pattern, and the texture layer has a degree of stretching less than that of the transparent layer. Refer to, for example, FIG. 1C.

Based on the above, the automotive ornament of the disclosure is stretched by the transparent layer to cover the top surface and the sidewall of the texture layer and the sidewall of the substrate, instead of combining the transparent layer and the texture layer and then to be stretched and to cover together. Therefore, the texture pattern in the texture layer is not offset or deformed due to the influence of the stretching force, so that problems such as the positioning and deformation of the texture pattern are effectively improved. Furthermore, the automotive ornament of the disclosure may have advantages such as simplifying the manufacturing process, reducing manufacturing costs, improving manufacturing efficiency, manufacturing yield, processing efficiency, and processing yield. In addition, since the texture pattern is covered by the transparent layer, the product surface have a dark decorative effect when the light source is not yet provided to the automotive ornament. When the light source is provided to the automotive ornament, due to the characteristic of the transparency of the transparent layer, the texture pattern produces a decorative effect, which improves the diversity of the automotive ornament.

Although the disclosure has been described with reference to the above embodiments, they are not intended to limit the disclosure. It will be apparent to one of ordinary skill in the art that modifications and changes to the described embodiments may be made without departing from the spirit and the scope of the disclosure. Accordingly, the scope of the disclosure will be defined by the attached claims and their equivalents and not by the above detailed descriptions.

1. An automotive ornament, comprising:
a substrate comprising a first surface and a second surface opposite to the first surface;
a texture layer disposed on the first surface, wherein the texture layer comprises a texture pattern; and
a transparent layer extending from a top surface of the texture layer to cover a sidewall of the texture layer and a sidewall of the substrate, wherein the transparent layer covers the texture pattern, and the texture layer has a degree of stretching less than a degree of stretching of the transparent layer.

2. The automotive ornament according to claim 1, wherein the transparent layer comprises a transparent leather, an adhesive film, or wood veneer.

3. The automotive ornament according to claim 1, wherein the texture layer comprises ink or black paint.

4. The automotive ornament according to claim 1, further comprising a thickening layer disposed between the substrate and the transparent layer, wherein the thickening layer is composed of a transparent substrate, a leather layer, and the texture layer, and the thickening layer extends from the first surface of the substrate to cover the sidewall of the substrate.

5. The automotive ornament according to claim 1, further comprising a light-emitting element and a circuit board, wherein the light-emitting element and the circuit board are disposed on the second surface of the substrate, and the light-emitting element is electrically connected to the circuit board.

6. The automotive ornament according to claim 5, wherein the light-emitting element is a micro light-emitting element in the circuit board.

7. A manufacturing method for an automotive ornament, comprising:
providing a substrate with a surface comprising a texture layer, wherein the texture layer comprises a texture pattern; and
stretching the transparent layer so that the transparent layer extends from a top surface of the texture layer to cover a sidewall of the texture layer and a sidewall of the substrate, wherein the transparent layer covers the texture pattern, and the texture layer has a degree of stretching less than a degree of stretching of the transparent layer.

8. The manufacturing method for the automotive ornament according to claim 7, wherein the transparent layer comprises an adhesive film formed by a three-dimensional overlay method.

9. The manufacturing method for the automotive ornament according to claim 7, wherein the texture layer is not substantially stretched when the transparent layer is stretched.

10. The manufacturing method for the automotive ornament according to claim 7, wherein the texture pattern is formed by a laser engraving method or a printing method.
